(19) United States
(12) Patent Application Publication
(10) Pub. No.: US 2007/0286775 A1
(43) Pub. Date: Dec. 13, 2007

(54) TRANSPORTER

(76) Inventor: Peter A.K. Yong, Torrance, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/756,990

(22) Filed: Jun. 1, 2007

Related U.S. Application Data
(60) Provisional application No. 60/811,633, filed on Jun. 7, 2006.

(51) Int. Cl. B01L 3/00

(52) U.S. Cl. 422/102

(57) ABSTRACT

A specimen transporter includes a reusable carrier having an openable top with a disposable rack insertable into the carrier. The rack includes a plurality of openings for supporting a plurality of specimen bottles in an upright spaced apart relationship. The rack is foldable for storage in a collapsed form. At least one compartment is disposed between a sidewalls and the rack and at least one ice pack is disposable within the compartment for cooling the specimen.

This application claims priority from U.S. Provisional Patent Application Ser. No. 60/811,633 filed Jun. 7, 2006 and is incorporated herewith in its entirety.

The present invention is generally related to specimen handing and is more particularly related to storage and transportation of specimen bottles.

There are estimated 50 to 100 million urinalysis carrier out in the U.S. alone each year.

Approximately, 75& to 80% of these specimens are for random urinalysis or, are unworthy of further investigation.

The importance of proper specimen collection, transportation, and handling is to avoid further introducing pre-analytical errors into the testing.

As with any type of laboratory specimen, there are certain criteria which need to be observed (very often never been taken seriously) for proper collection, transportation, and handling of these valuable specimens. This will ensure proper bio-stability of the specimen and more accurate test results.

Since a variety of urine collection procedures and applications exist today, it becomes critical to understand how and where things go wrong in the testing results.

Urinalysis is the second largest clinical lab test procedures world wide, daily handling and transportation of such specimens are in the millions. There is always an inexhaustible need for innovation to handle these voluminous specimens hygienically, and scientifically; unfortunately, there are hardly any companies striving to meet that need and, this remains one of the largest and most underserved medical device market today, however, it is of no value to the urine specimens if they are no longer lab-worthy for analytical testing; simply because of improper handling during transportation.

From research studies, normally when 60 to 70 urine specimens are transported in regular plastic cup containers, a large carton box measuring 2 feet by 2 feet in dimension is required. The average weight of these 70 specimen transported in this method is 8 to 10 pounds.

These containers are always thrown into a heavy-duty black garbage plastic bag to be carried away totally unorganized by the lab carrier. Any improperly closed container will result in urine leak, soling and wetting of the rest of the bulk containers. This most unhygienic and hazardous “scenario” will be faced by the lab tech on arrival at the lab. The next action is even more unpleasant; where all the 70 soiled and wet containers have to be picked out one by one to perform the analysis. In some instance many of these bulk containers are stacked up in the refrigerated room awaiting testing by appropriate lab tech at appropriate time. Such type of unhealthy environment should not be endorsed forcibly to these innocent lab techs. Their noble profession and precious life should also be respected and safeguarded by the health care industrial managements.

### SUMMARY OF THE INVENTION

A transporter in accordance with the present invention is comparable to a lady's cosmetic case and is able to carry 60 to 70 sampling syringes, each contains 10 ml of specimen, adequate for any standard random urinalysis test. The maximum weight of the 70 specimens plus the container weighs no more than 3 pounds!

Each sample is securely inserted into the rack all in up-right position. They may even be organized in a chronological fashion according to the time of collection.

Refrigerant or coolant slabs are inserted into the side pockets within the container to create a more bio-stable and cooler environment in order to protect the samples during the transportation period. These refrigerant slabs are easily re-freezable for re-use again.

The disposable specimen rack is made of recycle cardboard material. The bottom part of the rack has absorbent properties for accidental situation. Each rack is stored compactly in a collapsed form. When needed, it is easily folded upon to form the sample rack. To maintain hygienic standards, each sample rack is advised to be disposed off after every testing dispatch and a new one is replaced easily.

The transporter includes a carrier made of BREAK-RESISTANCE plastic. It has a strong and ergonomic handle for the carrier. The locking mechanism of the lid is easy and effective. This bulk transport container is reusable.

More particularly, a specimen transporter in accordance with the present invention generally includes a reusable carrier having a bottom, upstanding sidewalls and a openable top.

A disposable rack is sized for insertion into the carrier and includes a top with a plurality of top openings for supporting a plurality of specimen bottles in an upright spaced apart relationship. The rack is foldable for storage in a collapsible form. A plurality of disposable racks stored in collapsible form are part of the present invention.

At least one compartment is disposed between one of the sidewalls and the rack for receiving an ice pack for creating a more bio-stable and cooler environment, as hereinabove noted.

As also hereinabove noted, the rack includes an absorbent bottom and is preferably formed from an absorbent cardboard material.

Two opposing upstanding ends are provided as part of the rack to facilitate insertion and removal of the rack from the carrier and for that purpose finger openings may be provided in the upstanding ends.

In order to stabilize the specimen bottles within the openings, each opening may include an iris with separatable tabs.

Further, bottom openings may be provided and aligned with the top openings for maintaining the upright position of each specimen bottle.

Finally, the rack may include legs for supporting the rack bottom in a spaced apart relationship with the carrier bottom.

### BRIEF DESCRIPTION OF THE DRAWINGS

The advantages and features of the present invention will be better understood in conjunction with the accompanying drawings, in which:

FIG. 1 is a perspective view of a transporter in accordance with the present invention generally showing a reusable carrier, with a disposable rack inserted therein along with a plurality of specimen bottles and an ice pack;

FIG. 2 is a perspective view of the rack shown in part in FIG. 1 in an unfolded position having a top, bottom with openings therein for supporting the specimen bottles, legs for supporting the rack in a spaced apart relationship with a carrier bottom and upstanding ends for facilitating griping thereof;

FIGS. 3-5 illustrate folded and partially folded configurations of the rack;

FIG. 6 illustrates a stack of folded racks in a compact configuration for reduced storage space;

FIG. 7 illustrates an iris configuration of tabs for stabilizing specimen bottles within corresponding openings; and

FIG. 8 is a side view of the transporter shown in FIG. 1 showing compartments for receiving ice packs.

### DETAILED DESCRIPTION

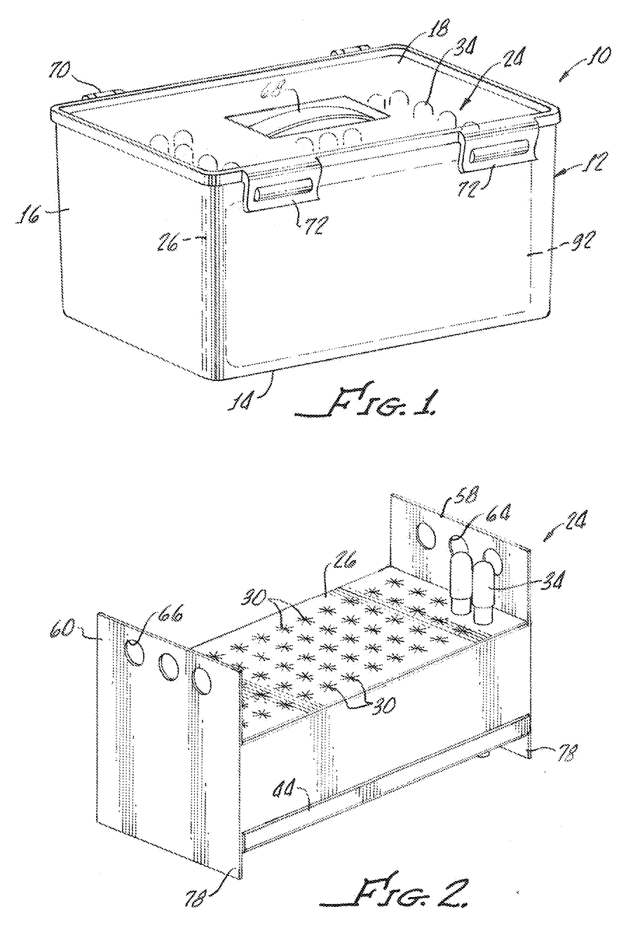

With reference to FIG. 1, there is shown a specimen transporter 10 in accordance with the present invention which includes a reusable carrier which may have dimensions of approximately 12 inches long by 8 inches wide with a bottom 14, upstanding sidewalls 16, and an openable top 18.

The sidewalls 16 have sufficient height for receiving a disposable rack 24 which includes a rack top 26 having a plurality of top openings 30 for supporting a plurality of specimen bottles 34, for example 50 to 70, in an upright spaced apart relationship, see FIG. 2.

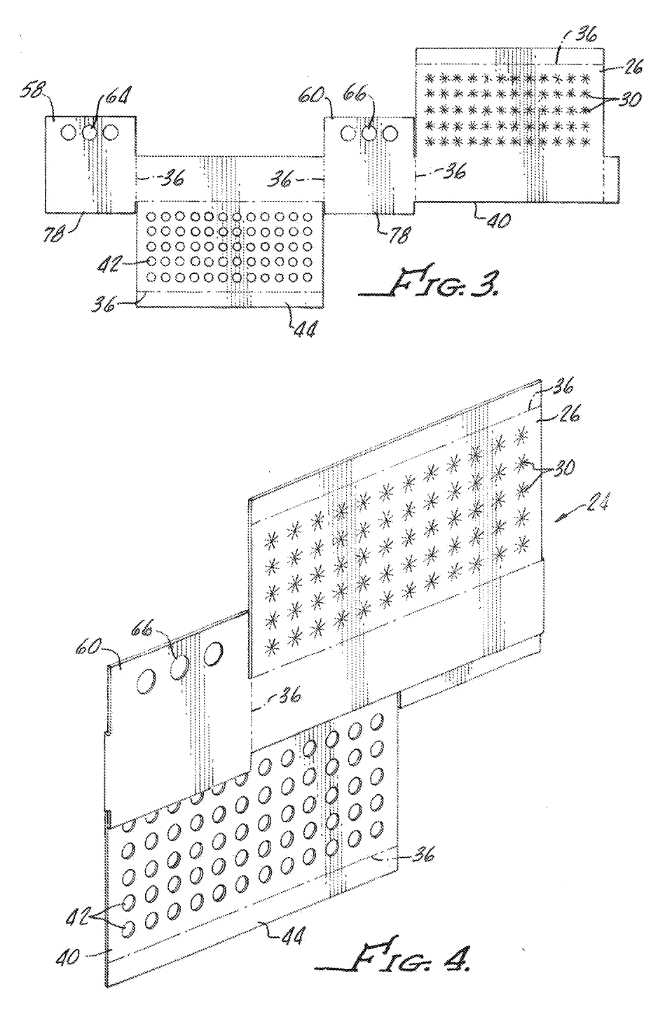

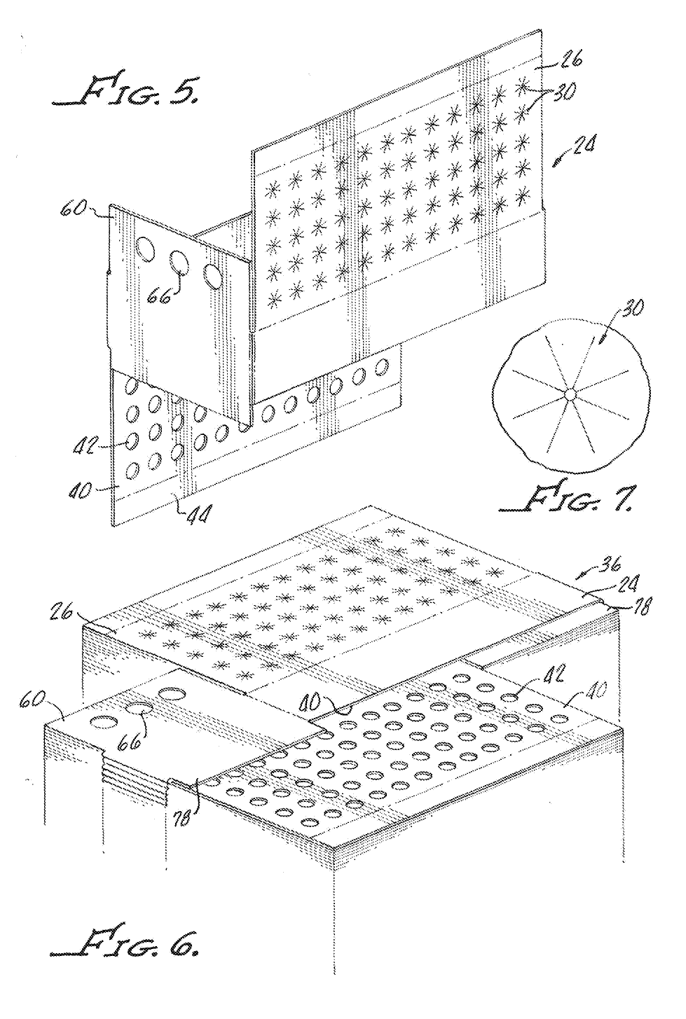

The rack 24 is preferably formed from an absorbent cardboard material and, as shown in FIGS. 3-5 is foldable along folded lines 36 for storage in a collapsed form, see FIG. 6. In this manner, a plurality of racks may be folded and stored in a compact manner, i.e. a stack, for later individual erection and insertion into the carrier 12 in a serial manner.

The rack may include an absorbent bottom 40 in order to absorb any inadvertent leakage of specimen to prevent a contamination of an adjacent specimen bottle 34.

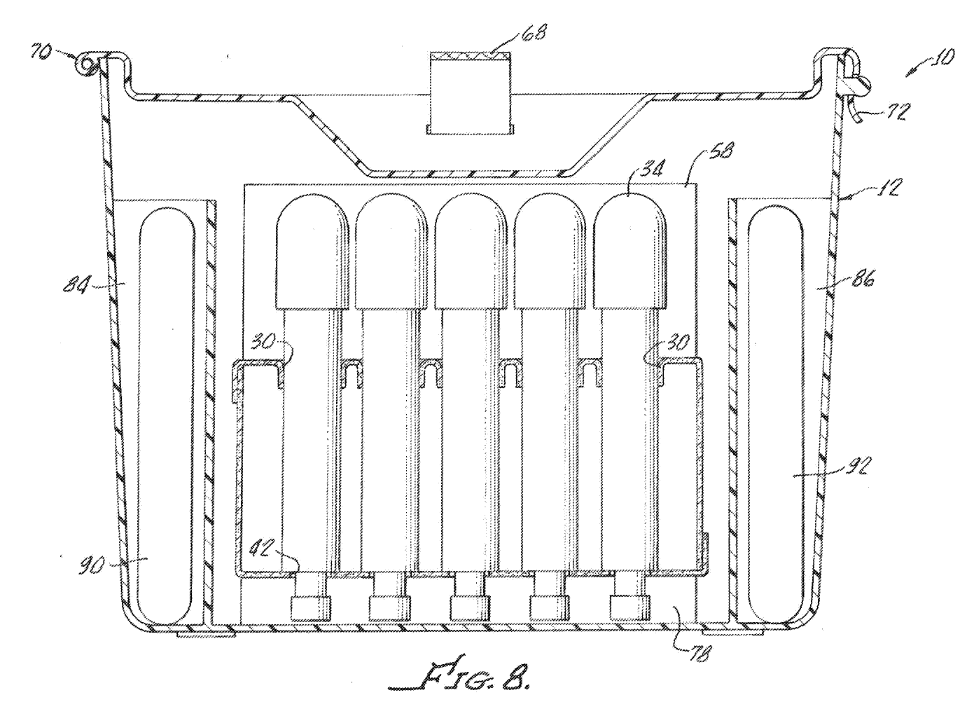

In order to both stabilize and maintain a generally vertical, or upright, orientation of the bottles 34 in the rack 24, the rack bottom 40 may also include a plurality of bottom openings 42 which are aligned with corresponding top openings 30, as shown in FIGS. 3-5. Independent stabilization of the rack 24 without the bottles 34 is provided by tape 44, as shown in FIG. 7.

To further stabilize and hold the specimen bottles 34 within the rack 24, the top openings 30 may include irises 46 having an outside perimeter 48 defining each top opening 30 with separatable tabs 50 extending from the perimeter 48 to a top opening center 54.

Upon insertion of a specimen bottle, the tabs 50 are separated and exert a uniform radially inward force on each of the bottles 34.

With reference to FIGS. 2-6, the racks 24 may be provided with upstanding ends 58, 60 which include finger openings 64, 66 to facilitate the placement and removal of the rack 24 in the carrier 12.

The top 18 is fitted with a handle 68 to enable easy transport of the transporter 10.

The top 18 may be hinged 70 to a sidewall 16 of the carrier 12 and clasps 72, 74 are provided for removably locking and sealing of the top 18 to the sidewalls 16. Alternatively, additional clasps (not shown) may be used to enable removal of the top 18 from the sidewalls 16.

With reference to FIGS. 2-8, the rack 24 may include legs 78 for supporting the rack bottom 38 in a spaced apartment with the carrier bottom 14.

With reference to FIG. 8, the carrier 12 includes compartments 84, 86 and the transporter 10 further includes ice packs 90, 92 insertable into the compartments 84, 86 for providing a cooling biocompatible environment within the transporter 10 for the specimen bottles 34.

Although there has been hereinabove described a specific transporter in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A specimen transporter comprising:
a reusable carrier having a bottom, upstanding sidewalls, and an openable top;
a disposable rack insertable in the carrier and having a top with a plurality of top opening for supporting a plurality of specimen bottles in an upright spaced apart relationship, the rack being foldable for storage in a collapsed form;
at least one compartment disposed between one of the sidewalls and the rack; and
at least one ice pack disposable within the compartment.

2. The transporter according to claim 1 wherein the rack includes an absorbent bottom.

3. The transporter according to claim 2 wherein the rack formed from a cardboard material.

4. The transporter according to claim 3 wherein the rack is foldable to a flat collapsed form.

5. The transporter according to claim 4 wherein the rack includes two opposing upstanding ends for facilitating insertion and removal from the carrier.

6. The transporter according to claim 5 wherein the upstanding end includes finger openings for gripping the upstanding ends.

7. The transporter according to claim 6 wherein each of the plurality of top opening includes an iris with separtatable tabs for stabilizing a corresponding specimen bottle therein.

8. The transporter according to claim 2 wherein the each bottom includes a plurality of bottom opening for supporting the plurality of specimen bottles, each bottom opening being aligned with a corresponding top opening.

9. The transporter according to claim 8 wherein the carrier bottom includes at least one depending member for supporting the rack bottom in a spaced apart relationship with the carrier bottom.

10. A specimen transporter comprising:
a reusable carrier having a bottom, upstanding sidewalls, and an openable top;
a plurality of disposable rack insertable in the carrier and each having a top with a plurality of top opening for supporting a plurality of specimen billets in an upright spaced apart relationship, the rack being foldable for storage in a collapsed form;
at least one compartment disposed between one of the sidewalls and the rack; and
at least one reusable ice pack disposable within the compartment.

11. The transporter according to claim 10 wherein each rack includes an absorbent bottom.

12. The transporter according to claim 11 wherein each rack if formed from a cardboard material.

13. The transporter according to claim 12 wherein each rack is foldable to a flat collapsed form.

14. The transporter according to claim 13 wherein each rack includes two opposing upstanding ends for facilitating insertion and removal from the carrier.

15. The transporter according to claim 14 wherein the upstanding ends include finger openings for gripping the upstanding ends.

16. The transporter according to claim 15 wherein each of the plurality of top opening includes an iris with separtatable tabs for stabilizing a corresponding specimen bottle therein.

17. The transporter according to claim 11 wherein each rack bottom includes a plurality of bottom opening for supporting the plurality of specimen bottles, each bottom opening being aligned with a corresponding top opening.

18. The transporter according to claim 17 wherein the each includes legs for supporting the rack bottom in a spaced apart relationship with the carrier bottom.
